(19) United States
(12) Patent Application Publication
(10) Pub. No.: US 2015/0122151 A1
(43) Pub. Date: May 7, 2015

(54) PELLETIZED ADDITIVE BLENDS WITH HIGH EXTRUSION THROUGHPUT RATE

(71) Applicant: Ingenia Polymers, Inc., Houston, TX (US)

(72) Inventors: Ananda M. Chatterjee, Missouri City, TX (US); Sumitra Subrahmanyan, Houston, TX (US)

(21) Appl. No.: 14/532,044

(22) Filed: Nov. 4, 2014

Related U.S. Application Data
(60) Provisional application No. 61/899,789, filed on Nov. 4, 2013.

(51) Int. Cl. C08K 5/098; C08K 5/52; B29B 9/06; C08K 5/134

(52) U.S. Cl. CPC C08K 5/098; C08K 5/134; C08K 5/52; B29B 9/06; B29K 2105/0005
USPC 106/503; 106/504; 264/143

(57) ABSTRACT

A melt extrusion process for producing pelletized 100% additive blends using additives with lower Hausner ratio and larger particle size with granular form, compared to powder form of additives; also additive blends produced by such process. Extrusion throughput rate is increased using granular additive particle form with lower Hausner ratio than that of powder form. The productivity and efficiency of the process is enhanced by using a larger particle size of additives. Additive blends and polymer stabilization agent blends can be added in post-polymerization processes in resin manufacturing plants to enhance the processing and performance properties of polymers.

This application claims priority to U.S. Provisional Patent Application Ser. No. 61/899,789, entitled “PELLETIZED ADDITIVE BLENDS WITH HIGH EXTRUSION THROUGHPUT RATE,” filed Nov. 4, 2013, the entire content of which is incorporated by reference.

### BACKGROUND

The invention relates generally to the field of polymer additives and specifically to melt extruded additive blends, or polymer stabilization agent blends, which can be added in post-polymerization processes in resin manufacturing plant to enhance the processing and performance properties of polymers.

Additives are typically used to protect polymers from thermo-oxidative degradation, to provide long-term resistance to heat or light (including ultraviolet), to neutralize residual catalyst, and to enhance processing and various performance properties of the finished polymer. Additives for polymers typically come in liquid, powder, granular, bead, pastille, or pellet form. Such additives can be added to the polymer during post-reactor extrusion operations.

Numerous techniques may be employed to introduce additives to a polymer in the process stream. In solution, suspension, or slurry phase polymerization processes, additives and additive blends can be added to a liquid before being introduced to the post-reactor polymer-liquid slurry. Alternatively, the additives can be added to the final melt stream of a polymer via a side arm extruder or other device which can melt some of the additives and mix them with the polymer. In this case, there will typically be mixing via an extruder or other mixing device and pumping of the polymer/additive mixture through a die for pelletizing the final polymer resin.

In other polymerization processes such as those using a gas phase reactor, the polymer exits the reactor as a coarse powder-like “reactor granule.” In this case, additives can be added to the polymer in several different ways. The additives can be added to the solid “reactor granule” powder stream, which can later be packaged as a final saleable product, or the additives can be further fed to an extruder or other melt mixing device in order to mix and homogenize the polymer-additive mixture and disperse the additives into the molten polymer. When additives are added to the solid “reactor granule” powder stream, the additives can be introduced in their neat forms, typically powder, or via a concentrate or masterbatch form. This mixture is subsequently pumped through a die for pelletization. Alternatively, in this type of process, additives can be introduced via a side arm extruder. The side arm extruder melts some of the additives and feeds them into a molten polymer stream where they are further mixed into the final polymer and pelletized.

If the polymer system requires the addition of several additive components, the additives must either be pre-blended, or added using multiple feeders. There are problems during the handling and feeding the additives in powder form to the extruder. Preparation of non-dusting pellet forms of additive blends solves these problems. Among these processes, extrusion of the 100% or all-additive blend to form pellets has been used and discussed before. U.S. Pat. No. 5,240,642 describes a process for making low-dust granules of an additive blend including a phenolic antioxidant and an acid neutralizer, using an extruder. This patent teaches powder feed as the starting material blend. U.S. Pat. No. 5,844,042 describes pellets of additive blends prepared by extrusion process. The additive blend is forced through a die to form strands and then said strands are cut to form pellets. This patent also teaches the use of additive powder as feed material for the extruder.

U.S. Pat. No. 5,597,857 describes extruded additive blend pellets comprising 10-100% calcium stearate. The calcium stearate feed is used in powder form. At least 80% by weight of the calcium stearate is melted, and the blend is forced through a die, then cooled by water (e.g. water ring) or air.

While the above methods of producing pellets from melt-extruded additive blends have been reported, there has been no method taught for increasing output or throughput rate of the extrusion process. The technology was limited to the low output rate obtainable from the powder form of the additives used. The present invention provides improved technology for increasing throughput or production rate of such 100% additive blends by using a granular form of additive of preferred larger particle size, which is distinct from the powder form of additives used in prior art. The present invention makes the process commercially and economically more useful and attractive by allowing for increasing output rate during melt extrusion processing of additive blend to pellet. The increased production rate provided by the present invention has a significant positive impact on profitability and overall product viability in the marketplace.

### SUMMARY

The present invention relates to methods of increasing output or throughput rate of melt extruded additive blends. Increased throughput rates during extrusion are achieved by using free-flowing granular forms of additives instead of powder forms. The present invention provides desirable particle sizes and Hausner ratio (ratio of tapped to loose bulk density) of the granular forms of the additive, depending on the additive type.

### DETAILED DESCRIPTION

The present invention relates to methods of increasing output or throughput rate of melt extruded additive blends.

Polymer additives are available in various particle sizes and shapes, for example, powder, free-flowing granular form, and so on. Smaller particles release dust into the air during processing, creating an explosion possibility and health related hazards. There is less dusting associated with the use of granular form additives compared to powders.

The present invention provides increased throughput rates during extrusion by using free-flowing granular forms of additives instead of powder forms. The present invention provides desirable particle sizes of the granular forms of the additive, depending on the additive type. The Hausner ratio of the additives is preferably between about 1.02 and about 1.25, depending on the additive.

In certain embodiments, one or more acid neutralizers are utilized as additives having a median particle size greater than about 100 microns and less than about 2000 microns and a Hausner ratio of between about 1.02 and about 1.16. The acid neutralizer additive may be calcium stearate, zinc stearate, sodium stearate, lithium stearate, or magnesium stearate.

In one embodiment of the present invention, calcium stearate having a median particle size greater than 100 microns (micrometer) is used as an additive during extrusion of a 100% additive blend. Calcium stearate having a median particle size greater than 150 microns and a Hausner ratio of less than about 1.20, as well as calcium stearate having a median particle size greater than 400 microns and a Hausner ratio of less than about 1.15, is used in other embodiments.

A separate embodiment of the invention provides phenolic antioxidants as the additive having a median particle size greater than about 1000 microns and less than about 6000 microns. In some embodiments the median particle size is greater than 1500 microns or greater than 2000 microns. The phenolic antioxidant additive may be tetrakis[methylene-3(3,5-di-tertiary butyl-4-hydroxyphenyl) propionate]methane, octadecyl-3(3,5-di-tertiary-butyl-4-hydroxyphenyl) propionate, tris(3,5-di-tertiary butyl-4-hydroxybenzyl) isocyanurate, 1,3,5-trimethyl, 2,4,6 tris (3,5 di-tertiary butyl-4-hydroxybenzyl)benzene, 1,2-bis(3,5-di-tertiary butyl-4-hydroxy hydrocinnamoyl) hydrazine, 1,3,5-tris(2,6 dimethyl 3-hydroxy 4-tertiary butyl benzyl) isocyanurate, 2,2′ethylidene bis(4,6-di-tertiary-butyl phenol), or mixtures thereof. In certain embodiments, the phenolic antioxidant additive is tetrakis[methylene-3(3,5-di-tertiary butyl-4-hydroxyphenyl) propionate]methane having a median particle size of greater than about 1700 microns. In other embodiments, the phenolic antioxidant additive is tris(3,5-di-tertiary butyl-4-hydroxybenzyl) isocyanurate having a median particle size of greater than 2300 microns.

In further embodiments, the additive includes a phosphite or phosphonite additive having a median particle size between about 1000 microns and about 6000 microns and a Hausner ratio of between about 1.02 and about 1.20. In some embodiments the median particle size is greater than about 1500 microns or greater than 2000 microns. The phosphite or phosphonite additive may be tris(2,4-di-tertiary-butyl phenyl)phosphite, bis(2,4-di-tertiary-butyl phenyl)penta-erythritol diphosphite, bis(2,4-dicumyl phenyl)penta-erythritol diphosphite, tetrakis(2,4-di-tert-butylphenyl)-1,1-biphenyl-4,4′-diylbisphosphonite, or mixtures thereof. In other embodiments, the phosphite or phosphonite additive is tris(2,4-di-tertiary-butyl phenyl)phosphite.

In certain embodiments, the additive blend is made up of calcium stearate and an antioxidant, such as an antioxidant that is a phenolic antioxidant or a phosphite antioxidant or combinations thereof. The antioxidant may comprise tetrakis[methylene-3(3,5-di-tertiary butyl-4-hydroxyphenyl) propionate]methane and tris(2,4-di-tertiary-butyl phenyl)phosphite. In one embodiment, the tetrakis[methylene-3(3,5-di-tertiary butyl-4-hydroxyphenyl) propionate]methane, tris(2,4-di-tertiary-butyl phenyl)phosphite, and calcium stearate are present in approximately equal amounts by weight.

The extrusion of the 100% additive blends can be conducted using a twin screw (preferred) or single screw extruder. The additive blend is charged into the feeder throat of the extruder, and the temperature zones are controlled such that at least one of the additives is melted and a homogeneous mixture of the additives is extruded out from the holes of the die in the form of a strand. The semi-solid strand is then cooled and finally cut into solid pellets which are substantially dust-free. The extrusion is carried out at a high throughput rate. In some embodiments, the throughput rate is 74 lb/hour and in some embodiments it is 95 lb/hour, using a twin screw extruder of 25 mm diameter in each case. This is a significant improvement in throughput rate for a 100% additive blend in a melt extrusion process. These rates are scaled up to higher rates for the same additive blend formulation, when extruders of larger diameter are used, as known and practiced in the industry.

The throughput rate of 74 lbs/hour using a twin screw extruder of 25 mm diameter is scaled up to higher rates using larger diameter extruder, for example approximately 491 lbs/hour using a 50 mm diameter twin screw extruder. Similarly the throughput rate of 95 lbs/hour using a twin screw extruder of 25 mm diameter is scaled up to higher rates, for example approximately 631 lbs/hour using a 50 mm diameter twin screw extruder.

### EXAMPLES

The particle form of additive in a blend was found to affect the maximum stable throughput rate from the Coperion ZSK-25 extruder. These effects varied depending on the type and nature of the additive, as well as the composition of the total blend.

The particle size and form of calcium stearate was found to have a significant effect on throughput rate. For example, calcium stearate powder Faci S (Faci Asia Pacific Pte Ltd, Singapore) has a median particle size of about 55 micron and is a very fine, dusty light material with low bulk density. In contrast, granular calcium stearate Faci SP has a median particle size of about 175 micron. Another granular form calcium stearate, SunAce GOF (Sun Ace Kakoh (Pte.) Ltd., Singapore), has a median particle size of about 415 micron.

Changing from an all-powder blend of Songnox 1010/Irgafos 168/calcium stearate to an additive blend containing free-flowing granular forms of all three additives (SONGNOX 1010 (Songwon Industrial Co., Ltd., Korea), IRGAFOS 168 (BASF, Germany), calcium stearate) increased the throughput rate by approximately 385% to 416%, depending on the particle size of the calcium stearate used.

The median particle sizes of the additives used in the examples below are shown in Table 1 below. The median particle size was measured by standard sieve analysis procedure known in the industry.

In the examples below Songnox 1010, a phenolic antioxidant, is tetrakis[methylene-3(3,5-di-tertiary butyl-4-hydroxyphenyl) propionate]methane; Irgafos 168, a phosphite antioxidant is tris(2,4-di-tertiary-butyl phenyl)phosphite. Songnox 3114, a phenolic antioxidant is tris(3,5-di-tertiary butyl-4-hydroxybenzyl) isocyanurate.

The additives were also characterized by their Hausner ratio, which is the ratio of tapped bulk density to standard (non-tapped or loose-packed) bulk density. The Hausner ratios of the additives are shown in the Table 1 below. Each bulk density was measured three times, and the average is reported here.

TABLE 1
Median Particle Size, Bulk Densities and Hausner
Ratio of Additives Used in Examples Below

| | Median | Loose Bulk | Tapped Bulk | Hausner |
|---|---|---|---|---|
| Additive and | Particle Size, | Density, | Density, | Ratio |
| Form | Micron | gm/100 cc (B) | gm/100 cc (T) | (T/B) |
| Songnox 1010 | 240 | 53.8 | 73.2 | 1.36 |
| Powder | | | | |
| Songnox 1010 | 1800 | 49.3 | 61.2 | 1.24 |
| Granular (FF) | | | | |
| Songnox 3114 | 138 | 57.8 | 79.6 | 1.38 |
| Powder | | | | |
| Songnox 3114 | 2375 | 58.0 | 69.6 | 1.20 |
| Granular (FF) | | | | |
| Irgafos 168 | 138 | 51.9 | 73.8 | 1.42 |
| Powder | | | | |
| Irgafos 168 | 1900 | 47.4 | 56.6 | 1.19 |
| Granular (FF) | | | | |
| Ca Stearate | 55 | 27.5 | 37.7 | 1.37 |
| Powder Faci S | | | | |
| Ca Stearate | 175 | 56.33 | 65.1 | 1.16 |
| Granular Faci | | | | |
| SP | | | | |
| Ca Stearate | 415 | 65.30 | 74.5 | 1.14 |
| Granular | | | | |
| SunAce GOF | | | | |

To test the reproducibility of the throughput rate, the throughput rate of a blend of Songnox 1010 powder, Irgafos 168 powder, and calcium stearate granular Faci SP was measured six times under nearly identical conditions. The coefficient of variation, defined as (standard deviation/mean)×100, was 7.1%. This indicates good reproducibility of throughput results, for the extrusion processing used.

Various additive blends were prepared, consisting of Irgafos 168 (33.3%), calcium stearate (33.3%), and Songnox 1010 or Songnox 3114 (33.4%). The particle size and form of each additive were varied to determine their effect on the throughput rate using a Coperion ZSK-25 twin screw extruder. Two forms each of Songnox 1010, Songnox 3114, and Irgafos 168 were used, namely a powder form (PW) and a granular free-flowing form (FF). Three forms of calcium stearate were used, namely Faci S which is a fine powder; Faci SP which has free-flowing granular form, and SunAce GOF which also has a free-flowing granular form of bigger particle size than Faci SP.

After the desired blend was prepared and thoroughly mixed by tumbling in a plastic bag, the blend was placed in the Brabender Powerflex 40 adjustable rate feeder attached to a Coperion ZSK-25 twin screw extruder. This extruder has 25 mm diameter and 40:1 length to diameter (L/D) ratio. For all runs, the maximum extrusion throughput or output rate was measured (and reported in Table 2 below) at a screw speed of 600 RPM. A six-strand die was used for extruding the additive blend strands which were cooled and cut into pellets in each experiment.

The experiments of Examples 1 through 8 below (with Songnox 1010, Irgafos 168 and Ca stearate) were conducted at extruder zone temperatures as noted below—

Zone 2 at 44° C.; Zones 3 and 4 at 64° C.; Zone 5 at 100° C.; Zones 6 and 7 at 124° C.; Zone 8 at 125° C.; Zones 9 and 10 at 126° C.; Die temperature, 126° C.
The typical torque measured was 20%. These conditions remained essentially similar in all these experiments with 1010; only the additive particle form and size were varied as shown in Table 2.

The experiments of Example 9 through 15 below, with Songnox 3114, Irgafos 168 and Ca stearate) were conducted at extruder zone temperatures of 44° C. (zone 2), 64° C. (Zones 3 and 4), 100° C. (zone 5), 124° C. (zones 6 and 7); 125° C. (zone 8), 126° C. (zones 9 and 10); 126° C. (die temperature). The typical torque measured was 20%. These conditions remained essentially similar in all experiments in the set below with 3114; only the additive particle form and size were varied as shown in Table 2.

The extruded strands were cooled by contact with a rotating chilled steel drum with surface temperature of about 10° C. The drum was chilled by placing ice inside it. The cooled strands were cut into pellets. The throughput rate was measured by cutting the strands at the die and allowing them to collect for 30 seconds, measured with a stop watch. At the end of 30 seconds, a second cut was made and the collected strands were again weighed. The average output rate was noted. The maximum achievable throughput rate (reported in Table 2 and examples below) for each blend formulation was the rate above which the extrusion process became unstable and not sustainable, as indicated by powder bridging, powder blocking the feed port, strand breakage, and/or phase separation of components in the strand.

The bulk density of the solid additive and Hausner ratio were measured by standard test procedure, using well established techniques (e.g see 7^{th} Supplement to US Pharmacopeia 23-NF18, Chapter 616, Nov. 15, 1997). The mass of additive sample contained in a 100 milliliter cup was measured. This provided the free-settling or loose-packed bulk density. Then the same measurement was performed after mechanically tapping the container from the outside until no further settling of the material inside the cup occurred; this procedure gave the tapped bulk density. The ratio of the tapped bulk density to loose-packed bulk density was calculated as Hausner ratio.

Pellet densities were measured using a digital caliper to determine the length, width, and thickness of each pellet, from which the volume of the pellet was calculated. The mass of each pellet was then measured using an analytical balance accurate to 0.0002 gram. A total of ten pellets were measured, and their densities (mass/volume) averaged to determine the pellet density for the blend sample.

TABLE 2
Extrusion Throughput Rate and Pellet Density as Function
of Additive Particle Form and Size

| | Songnox | Songnox | Irgafos | Calcium | Maximum | Pellet |
|---|---|---|---|---|---|---|
| Example | 1010 | 3114 | 168 | Stearate | Throughput Rate | Density |
| No. | (33.33%) | (33.33%) | (33.33%) | (33.34%) | (lb/hr) | (g/100 cc) |
| 1 | PW | — | PW | Powder | 18.6 | 63.3 |
| | | | | Faci S | | |
| 2 | PW | — | PW | Granular | 78.6 | 72.6 |
| | | | | Faci SP | | |
| 3 | PW | — | PW | Granular | 97.9 | 77.6 |
| | | | | SunAce | | |
| | | | | GOF | | |
| 4 | FF | — | FF | Powder | 27.2 | 70.8 |
| | | | | Faci S | | |
| 5 | FF | — | FF | Granular | 96.0 | 78.6 |
| | | | | Faci SP | | |
| 6 | FF | | FF | Granular | 101.2 | 81.6 |
| | | | | SunAce | | |
| | | | | GOF | | |
| 7 | FF | — | PW | Powder | 28.0 | 78.8 |
| | | | | Faci S | | |
| 8 | PW | — | FF | Powder | 24.0 | 73.6 |
| | | | | Faci S | | |
| 9 | — | PW | PW | Powder | 7.7 | 79.3 |
| | | | | Faci S | | |
| 10 | — | PW | PW | Granular | 54.5 | 83.8 |
| | | | | Faci SP | | |
| 11 | — | PW | PW | Granular | 90.3 | 77.1 |
| | | | | SunAce | | |
| | | | | GOF | | |
| 12 | — | FF | FF | Powder | 51.8 | 71.2 |
| | | | | Faci S | | |
| 13 | — | FF | FF | Granular | 107.9 | 74.4 |
| | | | | Faci SP | | |
| 14 | — | FF | FF | Granular | 74.8 | 44.4 |
| | | | | SunAce | | |
| | | | | GOF | | |
| 15 | — | FF | PW | Powder | 27.2 | 83.6 |
| | | | | Faci S | | |

Note:
PW—powder form;
FF—granular form

### Example 1

As seen in Table 2, in Examples 1-3, the additive formulation was Songnox 1010 powder (33.33%), Irgafos 168 powder (33.33%), and calcium stearate (33.34%). Calcium stearates of three different particle size were used. In Example 1, all-powder blend of Songnox 1010 powder, Irgafos 168 powder, and calcium stearate powder Faci S was extruded using the procedure and conditions described above. The measured throughput rate was only 18.6 lb/hr.

### Example 2

In Example 2, a blend of Songnox 1010 powder, Irgafos 168 powder, and calcium stearate granular form Faci SP was extruded using the procedure and conditions described above. The throughput rate was 78.6 lb/hr, showing a 322% improvement over powder Faci S of Example 1, where the throughput rate was only 18.6 lb/hr. The replacement of powder Faci S Ca stearate (Hausner ratio 1.37) by granular SP (Hausner ratio 1.16) resulted in significant extrusion throughput rate improvement of 322%.

### Example 3

In Example 3, a blend of Songnox 1010 powder, Irgafos 168 powder, and calcium stearate granular SunAce GOF was extruded using the procedure and conditions described above. The throughput rate was 97.9 lb/hr, which is 426% improvement over powder Faci S of Example 1.

### Example 4

In Example 4, a blend of Songnox 1010 FF, Irgafos 168 FF, and calcium stearate powder Faci S was extruded using the procedure and conditions described above. The throughput rate was 27.2 lb/hr. Comparing Example 4 with Example 1 (both with Ca stearate powder Faci S), it is observed that when the powder forms of both Songnox 1010 and Irgafos 168 are replaced with granular FF forms, the throughput increased from 18.6 to 27.2 lb/hr.

### Example 5

In Example 5, a blend of Songnox 1010 FF, Irgafos 168 FF, and calcium stearate granular Faci SP was extruded using the procedure and conditions described above. The throughput rate was 96 lb/hr. This was a 252.9% improvement over powder Faci S of Example 4.

### Example 6

In Example 6, a blend of Songnox 1010 FF, Irgafos 168 FF, and calcium stearate granular SunAce GOF was extruded using the procedure and conditions described above. The throughput rate was 101.2 lb/hr. This was a 272% improvement over powder Faci S of Example 4.

### Example 7

In Example 7, a blend of Songnox 1010 FF, Irgafos 168 powder, and calcium stearate powder Faci S was extruded using the procedure and conditions described above. The throughput rate was 28 lb/hr. This represents a 50.5% improvement over 18.6 lb/hr (of Example 1), due to 1010 FF granular form compared to 1010 powder.

### Example 8

In Example 8, a blend of Songnox 1010 powder, Irgafos 168 granular FF and calcium stearate powder Faci S was extruded using the procedure and conditions described above; it resulted in throughput rate of 24 lb/hr, or a 29% improvement over the rate (18.6 lb/hr) for 168 powder of Example 1 above.

Examples 9-15 described below were conducted with Songnox 3114 phenolic antioxidant, Irgafos 168 phosphite and Ca stearate.

### Example 9

In Example 9, a blend of Songnox 3114 powder, Irgafos 168 powder, and calcium stearate powder Faci S was extruded using the procedure and conditions described above. The throughput rate was only 7.7 lb/hr.

### Example 10

In Example 10, a blend of Songnox 3114 powder, Irgafos 168 powder, and calcium stearate granular Faci SP was extruded using the procedure and conditions described above. The throughput rate was 54.5 lb/hr. This represents 604% improvement over powder Faci S of Example 9.

### Example 11

In Example 11, a blend of Songnox 3114 powder, Irgafos 168 powder, and calcium stearate granular SunAce GOF was extruded using the procedure and conditions described above. The throughput rate was 90.3 lb/hr. This represents a 1070% improvement over Ca stearate powder Faci S of Example 9.

### Example 12

In Example 12, a blend of Songnox 3114 FF, Irgafos 168 FF, and calcium stearate powder Faci S was extruded using the procedure and conditions described above. The throughput rate was 51.8 lb/hr. Comparing Example 9 with Example 12 (both with Ca stearate powder Faci S), it is demonstrated that when the powder forms of both Songnox 3114 and Irgafos 168 are replaced with granular (FF) forms, the throughput increased from 7.7 to 51.8 lb/hr. Compared to all powder forms (7.7 lb/hr), a higher rate (51.8 lb/hr) was observed when 3114 and 168 were both used in FF forms.

### Example 13

In Example 13, a blend of Songnox 3114 FF, Irgafos 168 FF, and calcium stearate granular Faci SP was extruded using the procedure and conditions described above. The throughput rate was 107.9 lb/hr. This is a 108% improvement over powder Faci S of Example 12 (51.8 lb/hour).

### Example 14

In Example 14, a blend of Songnox 3114 FF, Irgafos 168 FF, and calcium stearate granular SunAce GOF was extruded using the procedure and conditions described above. The throughput rate was 74.8 lb/hr. This is a 44.4% improvement over powder Faci S of Example 12 (51.8 lb/hour).

### Example 15

In Example 15, a blend of Songnox 3114 granular FF, Irgafos 168 powder, calcium stearate powder Faci S, was extruded using the procedure and conditions described above; this run produced throughput of 27.2 lb/hr. This is a 251% improvement over 3114 powder (Example 9) which showed throughput rate of only 7.7 lb/hr.

### REFERENCES CITED

The following references, to the extent that they provide exemplary procedural or other details supplementary to those set forth herein, are specifically incorporated herein by reference.

### Non-Patent Literature

A. M. Chatterjee, Z. Liu, S. Subrahmanyan and S. D'uva, “Advancements in Additive Blends Technology for Polymers”, Proceedings of Society of Plastics Engineers (SPE) Polyolefins 2010 International Conference, Houston, Tex., February, 2010.

### Patent Documents

U.S. Pat. No. 5,240,642 issued Aug. 31, 1993, with Carlo Neri listed as the first inventor.
U.S. Pat. No. 5,844,042 issued Dec. 1, 1998, with Carlo Neri listed as the first inventor.
U.S. Pat. No. 5,597,857 issued Jan. 28, 1997, with Daniel Thibaut listed as the first inventor.

What is claimed is:

1. A method for preparing dust-free 100% additive blend pellets using melt extrusion, comprising:
blending two or more additives to produce an additive blend, wherein the additives are in free-flowing granular form having a large median particle size, wherein the solid additives have a Hausner ratio of between about 1.02 and about 1.25, and wherein the additive blend consists of 100% additives;
feeding the additive blend to an extruder feed hopper, the said extruder having controlled temperature zones;
controlling the temperature zones of the extruder so that at least one additive is melted;
extruding a homogeneous mixture of additives from the extruder at a high throughput rate to produce partially or fully molten strands by passage through a die; and
cooling followed by cutting the homogeneous strand of additive blend into solid pellets which are substantially dust-free.

2. The method of claim 1 wherein at least one additive is an acid neutralizer having a median particle size of greater than about 100 microns and less than about 2000 microns and having a Hausner ratio of between about 1.02 and about 1.16.

3. The method of claim 2 wherein the acid neutralizer additive is selected from the group consisting of calcium stearate, zinc stearate, sodium stearate, lithium stearate, and magnesium stearate.

4. The method of claim 2 wherein the acid neutralizer additive is calcium stearate.

5. The method of claim 1 wherein at least one additive is a phenolic antioxidant additive having a median particle size of greater than about 1000 microns and less than about 6000 microns.

6. The method of claim 5, wherein the phenolic antioxidant additive is selected from the group consisting of tetrakis[methylene-3(3,5-di-tertiary butyl-4-hydroxyphenyl) propionate]methane, octadecyl-3(3,5-di-tertiary-butyl-4-hydroxyphenyl) propionate, tris(3,5-di-tertiary butyl-4-hydroxybenzyl) isocyanurate, 1,3,5-trimethyl, 2,4,6 tris (3,5 di-tertiary butyl-4-hydroxybenzyl)benzene, 1,2-bis(3,5-di-tertiary butyl-4-hydroxy hydrocinnamoyl) hydrazine, 1,3,5-tris(2,6 dimethyl 3-hydroxy 4-tertiary butyl benzyl) isocyanurate, 2,2′ethylidene bis(4,6-di-tertiary-butyl phenol), and mixtures thereof.

7. The method of claim 5, wherein the phenolic antioxidant additive is tetrakis[methylene-3(3,5-di-tertiary butyl-4-hydroxyphenyl) propionate]methane having a median particle size of greater than about 1700 microns.

8. The method of claim 5 wherein the phenolic antioxidant additive is tris(3,5-di-tertiary butyl-4-hydroxybenzyl) isocyanurate having a median particle size of greater than 2300 microns.

9. The method of claim 1 wherein at least one additive is a phosphite or phosphonite additive having a median particle size of greater than about 1000 microns and less than about 6000 microns and having a Hausner ratio of between about 1.02 and about 1.20.

10. The method of claim 9 wherein the phosphite or phosphonite additive is selected from the group consisting of tris(2,4-di-tertiary-butyl phenyl)phosphite, bis(2,4-di-tertiary-butyl phenyl)penta-erythritol diphosphite, bis(2,4-dicumyl phenyl)penta-erythritol diphosphite, tetrakis(2,4-di-tert-butylphenyl)-1,1-biphenyl-4,4′-diylbisphosphonite, and mixtures thereof.

11. The method of claim 9, wherein the phosphite or phosphonite additive is tris(2,4-di-tertiary-butyl phenyl)phosphite.

12. The method of claim 1 wherein the high throughput rate is greater than 74 lb/hour using a twin screw extruder of 25 mm diameter.

13. A method for preparing dust-free 100% additive blend pellets using melt extrusion, comprising:
blending additives consisting of calcium stearate having a median particle size of greater than about 100 microns and less than about 2000 microns, tetrakis[methylene-3(3,5-di-tertiary butyl-4-hydroxyphenyl) propionate]methane having a median particle size of greater than about 1700 microns and less than about 6000 microns, and tris(2,4-di-tertiary-butyl phenyl)phosphite having a median particle size of greater than about 1000 microns and less than about 6000 microns to produce an additive blend, wherein the additives are in free-flowing granular form, and wherein the additive blend consists of 100% additives;
feeding the additive blend to a feed hopper of twin screw extruder having controlled temperature zones;
controlling the temperature zones of the extruder so that at least one additive is melted;
extruding a homogeneous mixture of additives from the extruder at a high throughput rate of greater than 95 lb/hour using a twin screw extruder of 25 mm diameter, to produce molten strands by passage through a die; and
cooling followed by cutting the homogeneous strands of additive blend into solid pellets which are substantially dust-free.

14. A method for preparing dust-free 100% additive blend pellets using melt extrusion, comprising:
blending additives consisting of calcium stearate having a median particle size of greater than about 100 microns and less than about 2000 microns, tris(3,5-di-tertiary butyl-4-hydroxybenzyl) isocyanurate having a median particle size of greater than 2300 microns and less than about 6000 microns, and tris(2,4-di-tertiary-butyl phenyl)phosphite having a median particle size of greater than about 1000 microns and less than about 6000 microns to produce an additive blend, wherein the additives are in free-flowing granular form, and wherein the additive blend consists of 100% additives;
feeding the additive blend to the feed hopper of a twin screw extruder having controlled temperature zones;
controlling the temperature zones of the extruder so that at least one additive is melted;
extruding a homogeneous mixture of additives from the extruder at a high throughput rate of greater than 74 lb/hour using a twin screw extruder of 25 mm diameter, to produce molten strands by passage through a die; and
cooling followed by cutting the homogeneous strands of additive blend into solid pellets which are substantially dust-free.

15. An additive blend pellet made according to the method of claim 1, comprising:
a) an antioxidant additive; and
b) calcium stearate;
wherein the antioxidant additive and the calcium stearate are in a granular free-flowing form having a large median particle size, wherein the neat antioxidant additive and the neat calcium stearate each have a Hausner ratio of between about 1.02 and about 1.25, and wherein the additive blend pellet consists of 100% additives.

16. The additive blend pellet of claim 15, wherein the calcium stearate has a median particle size of greater than about 150 microns and a Hausner ratio of less than about 1.20.

17. The additive blend pellet of claim 15, wherein the calcium stearate has a median particle size of greater than about 400 microns and a Hausner ratio of less than about 1.15.

18. The additive blend pellet of claim 15, wherein the antioxidant additive is selected from the group consisting of a phenolic antioxidant, a phosphite antioxidant, and combinations thereof.

19. The additive blend pellet of claim 15, wherein the antioxidant additive has a median particle size of greater than about 1500 microns and less than about 6000 microns.

20. The additive blend pellet of claim 15, wherein the antioxidant additive has a median particle size of greater than about 2000 microns and less than about 6000 microns and a Hausner ratio of less than about 1.22.

21. The additive blend pellet of claim 15, wherein the antioxidant additive is selected from the group consisting of tetrakis[methylene-3(3,5-di-tertiary butyl-4-hydroxyphenyl) propionate]methane; tris(3,5-di-tertiary butyl-4-hydroxybenzyl) isocyanurate; tris(2,4-di-tertiary-butyl phenyl)phosphite, and combinations thereof.

22. The additive blend pellet of claim 15, wherein the antioxidant additive comprises tetrakis[methylene-3(3,5-di-tertiary butyl-4-hydroxyphenyl) propionate]methane and tris(2,4-di-tertiary-butyl phenyl)phosphite.

23. The additive blend pellet of claim 22, wherein the tetrakis[methylene-3(3,5-di-tertiary butyl-4-hydroxyphenyl) propionate]methane, tris(2,4-di-tertiary-butyl phenyl)phosphite, and calcium stearate are present in approximately equal amounts by weight %.

24. The additive blend pellet of claim 16, wherein the calcium stearate is granular calcium stearate having a loose bulk density of 56 to 57 gm/100 cc, a tapped bulk density of 65 to 66 gm/100 cc, and a Hausner ratio of 1.14 to 1.18, or a granular calcium stearate having a loose bulk density of 65 to 66 gm/100 cc, a tapped bulk density of 74 to 75 gm/100 cc, and a Hausner ratio of 1.12 to 1.15.
